(19) United States
(12) Patent Application Publication
(10) Pub. No.: US 2026/0289581 A1
(43) Pub. Date: Sep. 24, 2026

(54) CARBON ASSURANCE SYSTEM

(71) Applicant: Halliburton Energy Services, Inc., Houston, TX (US)

(72) Inventors: Duane SHERRITT, Spring, TX (US); Glenn WILSON, Houston, TX (US); Misty DAVIS, Humble, TX (US); Ming ONGKWAN, Houston, TX (US)

(73) Assignee: Halliburton Energy Services, Inc., Houston, TX (US)

(21) Appl. No.: 19/086,460

(22) Filed: Mar. 21, 2025

(51) Int. Cl. G06Q 30/018

(52) U.S. Cl. CPC G06Q 30/018

(57) ABSTRACT

Aspects of the subject technology relate to systems, methods, and computer-readable media for verifying regulatory compliance and providing assurance of regulatory compliance through a distributed ledger. Specifically, data related to performing a CCUS process can be recorded to a distributed ledger. A first set of rules can be applied to the data to verify compliance with a first regulation. A second set of rules can be applied to the data to verify compliance with a second regulation. Tokens can be minted on the distributed ledger to represent compliance with the first regulation and the second regulation.

### BACKGROUND

### Technical Field

The present disclosure generally relates to providing assurance of regulation compliance in a carbon capture and storage (CCUS) process, and more specifically to providing assurance of regulation compliance in a CCUS process through a distributed ledger.

### Introduction

CCUS or carbon capture and storage (CCS) is the process of capturing carbon dioxide from the atmosphere (e.g. direct air capture), ocean, or an industrial process, e.g. pre-or post-combustion carbon dioxide gas streams and permanently preventing the CO₂ from entering or returning to the atmosphere. CO₂ may be used for a purpose such as enhanced oil recovery, manufacturing chemicals, or otherwise making durable products. CO₂ may be permanently stored in geological formations, such as saline aquifers or depleted oil and gas reservoirs.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a schematic diagram of an example wellbore operating environment, according to some examples of the present disclosure;

FIG. 2 illustrates a schematic representation of an example CCUS environment, according to some examples of the present disclosure;

FIG. 3 illustrates an exemplary blockchain network environment, according to some examples of the present disclosure;

FIG. 4 illustrates a flowchart of an example method of verifying regulatory compliance and providing assurance of regulatory compliance through a distributed ledger, according to some examples of the present disclosure;

FIG. 5 illustrates a schematic representation of an environment for minting tokens in association with CCUS processes, according to some examples of the present disclosure;

FIG. 6 illustrates a flowchart of another example method of verifying regulatory compliance and providing assurance of regulatory compliance through a distributed ledger, according to some examples of the present disclosure;

FIGS. 7A and 7B illustrate a flowchart of an example method of verifying regulatory compliance and providing assurance of regulatory compliance with three different regulations through a distributed ledger, according to some examples of the present disclosure;

FIG. 8 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As discussed previously, CCUS or CCS is the process of capturing carbon dioxide from the atmosphere (e.g. direct air capture), ocean, or an industrial process, e.g. pre-or post-combustion carbon dioxide gas streams and permanently preventing the CO₂ from entering or returning to the atmosphere. CO₂ may be used for a purpose such as enhanced oil recovery, manufacturing chemicals, or otherwise making durable products. CO₂ may be permanently stored in geological formations, such as saline aquifers or depleted oil and gas reservoirs.

The CCS operator must perform monitoring, reporting and verification or measurement monitoring and verification (MMV) to demonstrate that 1 metric ton of CO2 that was captured has been utilized or stored. The challenge is having a governance around MMV/MRV that enables transparent, auditable processes for verifying reported carbon utilization or storage. Specifically, the IRS Inspector General claimed that over half of the 45Q tax credits claimed between 2009 and 2020 were denied due lack of compliance with EPA monitoring, reporting, and measurement reporting and verification (MRV). This becomes even more daunting as CCUS environments grow in complexity and more entities are involved in providing verified reporting of carbon utilization and storage.

The disclosed technology addresses the foregoing by verifying regulatory compliance and providing assurance of regulatory compliance through a distributed ledger. Specifically, data related to performing a CCUS process can be recorded to a distributed ledger. A first set of rules can be applied to the data to verify compliance with a first regulation. A second set of rules can be applied to the data to verify compliance with a second regulation. Tokens can be minted on the distributed ledger to represent compliance with the first regulation and the second regulation.

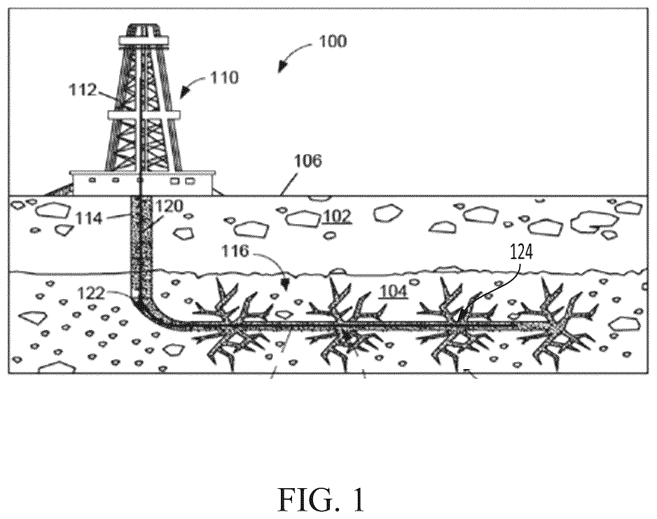

FIG. 1 illustrates a schematic diagram of an example wellbore operating environment 100. As depicted in FIG. 1, the operating environment 100 includes a wellbore 114 that penetrates a formation 102 for the purpose of recovering hydrocarbons, storing hydrocarbons, injecting water or carbon dioxide, or the like in formation 104. In certain embodiments, the purpose of the operating environment 100 is carbon capture and storage (CCS) and includes equipment associated with that purpose (not shown in FIG. 1). In certain embodiments, the purpose of the operating environment 100 is geothermal energy capture and includes equipment associated with that purpose (not shown in FIG. 1).

As depicted in FIG. 1, formations 102 and 104 are subterranean formations, although it is noted that formations 102 and 104 may be subsea formations. In certain locations, there are a plurality of underground formations 102, 104. The wellbore 114 may extend substantially vertically away from the Earth's surface 106 over a vertical wellbore portion, or may deviate at any angle from the Earth's surface 106 over a deviated or horizontal wellbore portion 116. In alternative operating environments, portions or substantially all of the wellbore 114 may be vertical, deviated, horizontal, and/or curved. The wellbore 114 may be drilled into the formations 102, 104 using any suitable drilling technique. As shown, a drilling or servicing rig 110 disposed at the surface 106 (which may be the surface of the Earth, a seafloor surface, or a sea surface) comprises a derrick 112 from which a tubular string 120 (e.g., a drill string, a tool string, a segmented tubing string, a jointed tubing string, or any other suitable conveyance, or combinations thereof) is positioned within or partially within the wellbore 114. The tubular string 120 may include two or more concentrically positioned strings of pipe or tubing (e.g., a first work string may be positioned within a second work string). The drilling or servicing rig 110 may include a motor driven winch and other associated equipment for lowering the tubular string into the wellbore 114. Alternatively, a mobile workover rig, a wellbore servicing unit (e.g., coiled tubing units), or the like may be used to lower the work string into the wellbore 114. In such an environment, the tubular string 120 may be utilized in drilling, stimulating, completing, or otherwise servicing the wellbore, or combinations thereof. A drilling or servicing rig 110 may also comprise other equipment. In certain types of operations, a fluid 122 is forced down the tubular string 120 and out through perforations 124 to fracture the formations 104 that surround the perforations 124.

While FIG. 1 depicts a stationary drilling rig 110, one of ordinary skill in the art will readily appreciate that mobile workover rigs, stimulation units (such as fracturing pumps), wellbore servicing units (such as coiled tubing units), and the like may be employed. It is noted that while the figures or portions thereof may exemplify horizontal or vertical wellbores, the principles of the presently disclosed apparatuses, methods, and systems, may be similarly applicable to horizontal wellbore configurations, conventional vertical wellbore configurations, deviated wellbore configurations, and any combinations thereof. The horizontal, deviated, or vertical nature of any figure is not to be construed as limiting the wellbore to any particular configuration or formation.

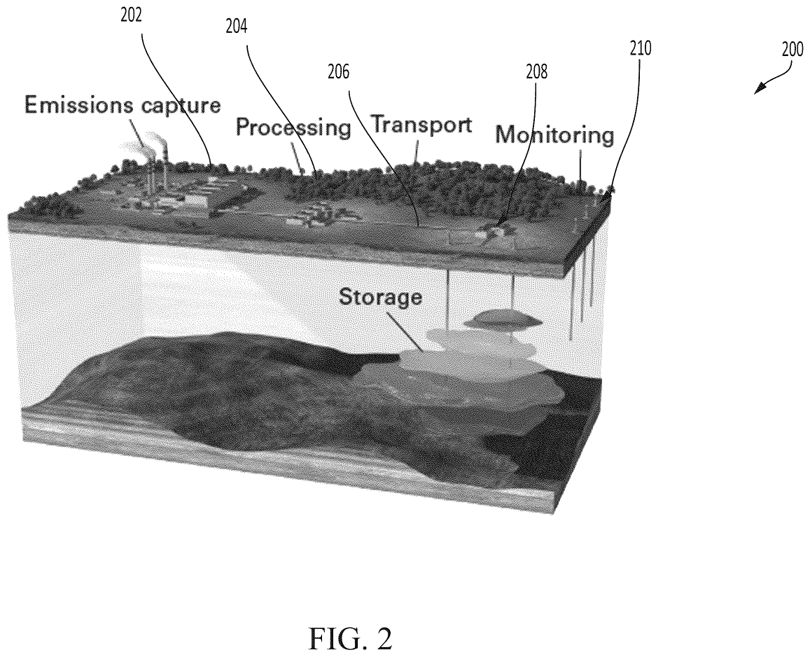

The disclosure now turns to a description of FIG. 2, which illustrates a schematic representation of a CCUS environment 200. The CCUS environment 200 comprises a capture facility 202, a processing facility 204, a transport system 206, a storage system/facility 208, and a monitoring system 210. The CCUS environment 200 is a simplified depiction of a CCUS environment and a CCUS environment can comprise multiple capture facilities, multiple processing facilities, multiple transport systems, multiple storage facilities, and multiple monitoring systems. Specifically, a CCUS environment can comprise one or more CCUS hubs. Hubs can comprise a transportation system/infrastructure that is shared by many capture facilities and many storage facilities, essentially acting as a central point for capturing and storing large volumes of carbon dioxide from a cluster of industries.

The capture facility 202 functions to capture carbon dioxide for purposes of storage. Specifically, the carbon capture facility captures carbon dioxide (CO₂), otherwise referred to as carbon herein, from industrial emissions, e.g. at power plants or factories, before it enters the atmosphere. For example, a coal fired power station can recover and fiscally meter carbon dioxide from a post combustion capture facility that would otherwise be vented to the atmosphere.

The processing facility 204 functions to process captured carbon for transportation through the transportation system to the storage facility 208. Specifically, the processing facility 204 can process captured carbon into a form that is suitable for transport over large distances to a storage facility. For example, the processing facility 204 can receive a gas stream of CO₂ that is processed into high purity CO₂, which is then dried, and compressed for transportation.

The transport system 206 functions to transport the carbon dioxide safely and efficiently from the processing facility 204 and capture facility 202 to the storage facility 208. The transport system 206 can comprise applicable systems from transporting carbon dioxide, such as rail, trucks, and pipelines. A pipeline should operate within a specific range of temperatures, pressures and flow rates along the way. Accordingly, the transport system 206, as will be discussed in greater detail later, can comprise sensors that measure these parameters for flow assurance. Further, the transport system 206 can comprise sensors that monitor carbon dioxide tonnage within the pipeline network to ensure that what was captured is delivered to its end destination at the storage facility 208.

The storage facility 208 is a site where captured carbon dioxide is permanently stored, effectively removing it from the atmosphere. For example, the storage facility 208 can be a geological formation into which carbon dioxide is injected and permanently stored. The storage facility 208 can comprise sensors to monitor the injected carbon to ensure that the tonnages of carbon dioxide injected/stored at the storage facility 208 matches what was delivered to the storage facility 208.

The monitoring system 210 functions to monitor the stored carbon dioxide to ensure that the carbon dioxide is stored safely and does not impact the environment. Specifically, the monitoring system 210 can validate that the carbon dioxide remains stored in the formation and does not migrate from the permitted geological store and into the surrounding area. The monitoring system 210 can comprise applicable sensors for monitoring stored carbon dioxide. Specifically, the monitoring system 210 can comprise CO₂ concentration detectors to measure the level of carbon dioxide in the surrounding environment, identifying potential leaks from the storage site. Example monitoring sensors include optical CO₂ sensors, atmospheric CO₂ tracers, eddy covariance flux measurement systems, and ground-based remote sensing to monitor the plume of CO2 above the storage area.

Real-time or near real-time monitoring from points of capture to storage can be used to ensure that the entire system remains compliant with various regulations, e.g. Environmental Protection Agency (EPA) class six compliance. End-to-end monitoring also advises on system level operations to reduce risk and drive operational efficiencies. Therefore, all of the capture facility 202, the processing facility 204, the transport system 206, the storage facility 208, and the monitoring system 210 can includes sensors for measuring CO₂, temperatures, pressure, and other applicable sensors, e.g. composition flow meters, that can be used to quantify unit masses of CO₂. Sensors in the CCUS environment 200 can require calibration, e.g. to ensure compliance with various regulations. Specifically, sensors can be calibrated every six months, 12 months, etc. This can ensure that accurate measurements are made with respect to CCUS operations.

Real-time, as used herein, can be defined as near instantaneous (e.g., consider sampling rates, etc.) and can include latency in communication (e.g., telemetry, etc.). For example, real-time can be instantaneous if communication between a controller and models are of zero latency. However, if the communication between a controller and models has as latency of 1 minute then real-time can be instantaneous plus 1 minute. In general, real-time means instantaneous plus latency or other system delay time. Other system delay time can include transmission time delay, acquisition time delay, processing time delay, or other system delays.

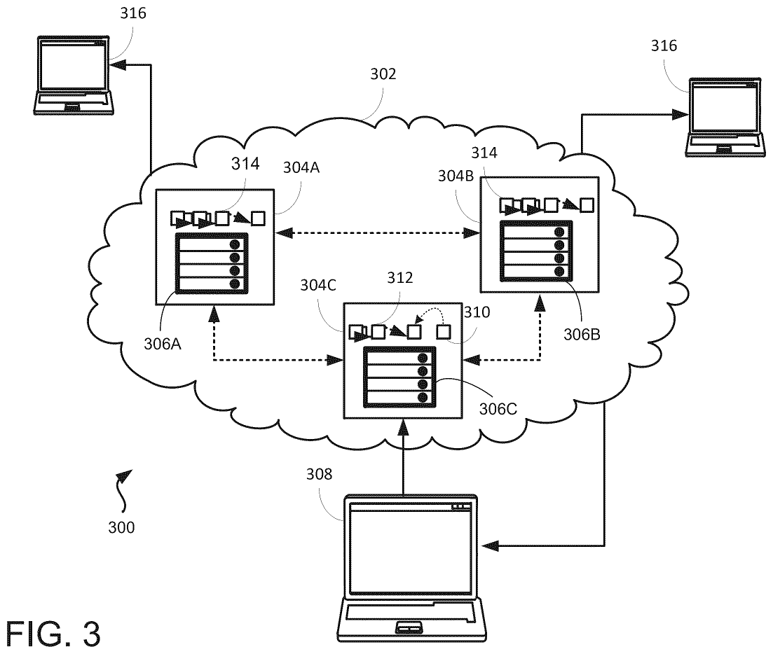

The disclosure turns now to FIG. 3, which shows an exemplary blockchain network environment 300, according to some examples of the present disclosure. While reference is made to the blockchain network environment 300 shown in FIG. 3, the technology described herein can be implemented on an applicable distributed ledger, including the blockchain represented in FIG. 3. Further, while FIG. 3 depicts one specific blockchain network environment 300 of the present disclosure, it is by no means the only blockchain network architecture on which the concepts herein can be implemented, as would be appreciated by one of ordinary skill in the art. Additionally, although blockchain network 300 is shown as comprising only a first blockchain, this is for purposes of clarity and it is appreciated that blockchain network 300 can comprise one or more additional blockchains without departing from the scope of the present disclosure.

Returning to FIG. 3, as shown, blockchain network 302 includes blockchain nodes 304A-C, which implement and maintain one or more blockchains of the present disclosure. These one or more blockchains are accessed and/or written to by one or more terminals 308 and 316. It is appreciated that a greater or lesser number of blockchain nodes 304A-C and terminals 308, 316 can be provided as desired without departing from the scope of the present disclosure. Additionally, although the blockchain nodes 304A-C are shown as being implemented on corresponding servers 306A-C, one or more of the blockchain nodes 304A-C in some embodiments may instead or also be an executable software application on a server and/or personal computer, a virtual machine, and the like. In instances where multiple blockchains are provided, the same blockchain nodes (e.g., nodes 304A-C) may implement each blockchain, or different groupings and combinations of blockchain nodes can be utilized to implement different blockchains, without departing from the scope of the present disclosure.

Each blockchain node 304A-C may intercommunicate and store copies of blockchains and similar data objects in local memory and/or in a remote memory or a data store. In some embodiments, each node 304A-C may store copies of each blockchain on the blockchain network 302, and access the blockchain network 302 and respective blockchain on an as needed basis.

Terminals 308 and 316 interact with blockchain network 302 via, for example, the Internet or some other communication network, public or private, wired or wireless. For purposes of example, as shown in FIG. 3, terminal 308 may update one or more stored blockchains within blockchain network 302 by transmitting an event transmission, record object, or other signal to node 304C within blockchain network 302. Node 304C may then process the received transmission in order to generate a new block 310 which can be added onto a respective blockchain 312. In some examples, there may be processes for randomizing which node assumes authority to update the blockchain such as, for example, a mining algorithm and the like (e.g., solving an easily verifiable but difficult to solve cryptographic puzzle such as determining appended characters which will cause a hash value to have a particular quality). In other examples, certain or all nodes may be granted authority to update blockchains by the system and any updates produced are taken presumed authentic and authoritative.

Node 304C may then transmit an updated blockchain 314 to each other node 304A-B in blockchain network 302. Updated blockchain 314 may include previous blockchain 312 with the new block 310 appended. In this manner, updated blockchain 314 may reflect a sequential expansion of the associated blockchain and may replace previous copies (e.g., copies not including new block 310) stored on a given node.

In some embodiments, the functionality of the above described blockchain nodes 304A-C and terminals 308, 316 can be combined, such that a single computing entity, whether physical or virtual, both implements a blockchain in concert with other blockchain nodes while also reading from and writing to that blockchain as desired.

In some embodiments, the blockchain network 302 (and the blockchain nodes 304A-C) may be implemented in a private fashion. In some embodiments, the blockchain network 302 might be implemented in private fashion, but by a third-party external to CCUS, such that the entities associated with CCUS operations only the access terminals 308, 316 for reading and writing to blockchains provided in a private blockchain cloud hosted by the external third-party. In some embodiments, the blockchain network 302 might be implemented as a public blockchain network, wherein one or more of the blockchain nodes 304A-C are not associated with a specific CCUS environment and are instead provided for example on the Internet.

In order to provide blockchain-based auditing, a plurality of blockchains can be implemented to provide a trusted permissioned ledger and repository. In some embodiments, one blockchain will be created for each entity associated with the CCUS process. In this manner, auditing and maintenance information otherwise independently collected and maintained by each entity is instead collated across entities and stored in a corresponding blockchain in a seamless and secure fashion, providing appropriately permissioned on-demand access to stored auditing information while simultaneously enforcing privacy, anonymization, and other functions across the entities.

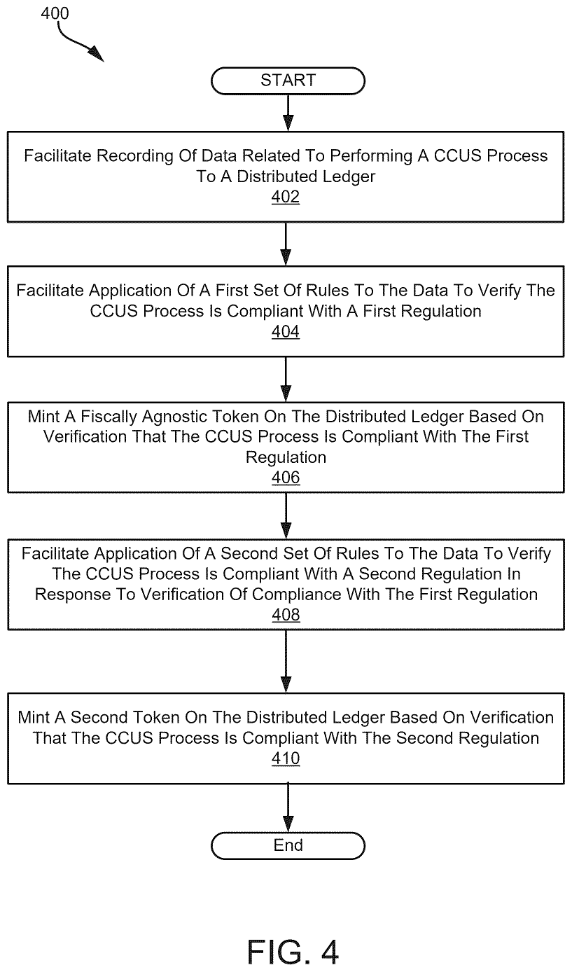

FIG. 4 illustrates a flowchart 400 of an example method of verifying regulatory compliance and providing assurance of regulatory compliance through a distributed ledger, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example environments described herein.

At module 402, the recording of data related to performing a CCUS process to a distributed ledger is facilitated. Specifically, an interface or other applicable system can be provided to an entity associated with performing a CCUS process through which the entity can record data related to performing the CCUS process. A CCUS process can include an applicable process that is performed during carbon capture, utilization, storage, and monitoring. For example, a CCUS process can comprise the actual capture of carbon dioxide, the transportation of carbon dioxide to a storage site, and the injection of the captured carbon into the storage site. An entity associated with performing a CCUS process can comprise an entity who actually performs the CCUS process. Further, an entity associated with performing a CCUS process can comprise an entity that facilitates performance of the CCUS process. For example, entities associated with a CCUS process can comprise an owner of a factory that emits carbon dioxide and a third party that is responsible for capturing the emitted carbon dioxide. Further, an entity associated with performing a CCUS process, as will be discussed in greater detail later, can comprise an auditor for performing an independent examination of the CCUS process, e.g. to verify regulation compliance.

In facilitating recording of data related to performing a CCUS process to a distributed ledger, the distributed ledger can interface with a supervisory control and data acquisition (SCADA) system associated with performing the CCUS process. A SCADA system associated with performing a CCUS process can comprise a system that controls or facilitates performance of the CCUS process. For example, a SCADA system can control injection of captured carbon dioxide into a formation. In another example, a SCADA system can monitor the flow of carbon dioxide through a transportation network. In facilitating interfacing between the SCADA system and the distributed ledger, an interface can be provided to the SCADA through which the SCADA can automatically record data to the distributed ledger. Further, an operator can access the SCADA system for data and record the data to the distributed ledger, e.g. through the interface.

Data related to performing a CCUS process comprises applicable data related to performance of the CCUS process. Specifically, data related to performing a CCUS process can comprise data related to capturing carbon dioxide, transporting carbon dioxide, and storing carbon dioxide. For example, data related to performance of a CCUS process can comprise conditions related to monitoring pressures, injection pressures, temperatures, flow rates, well, integrity, plume migration. Further, data related to performance of a CCUS process can comprise characteristics of compositions of tracked substances.

Data related to performing a CCUS process can comprise data associated with recalibrating equipment and systems in a CCUS environment. Specifically, data related to performing a CCUS process can comprise data verifying that specific equipment in the CCUS environment, e.g. sensors, were recalibrated. Further, data related to performing a CCUS process can comprise data indicating when the specific equipment was recalibrated. Verifying the recalibration of equipment such as sensors is technically advantageous as such verification can be required for meeting compliance with certain regulations.

At module 404, the application of a first set of rules to the data is facilitated to verify the CCUS process is compliant with a first regulation. Regulations, as used herein, can comprise applicable rules and standards that are defined and followed in relation to an aspect of carbon sequestration operations. The first set of rules corresponding to the first regulation can comprise a regulation that is fiscally agnostic. Fiscally agnostic, as used herein, can comprise the state of being independent of a position in a value structure or otherwise not acting as a security. Specifically, the first set of rules comprise one or more rules related to measuring and verifying an amount of carbon captured at a capture site. For example, the first regulation can comprise EPA subpart PP. Further, the first set of rules can comprise one or more rules related to storing and verifying an amount of carbon stored at a storage site. For example, the first regulation can comprise EPA subpart RR. Additionally, the first set of rules can comprise one or more rules related to monitoring and verifying continued storage of the amount of carbon at the carbon storage site. For example, the first regulation can comprise EPA subpart H.

At module 406, a fiscally agnostic token is minted on the distributed ledger based on verification that the CCUS process is compliant with the first regulation. The token can be minted based on the first set of rules. Specifically, the token can be minted based on application of the first set of rules to ensure that the CCUS process is compliant with the first regulation. The token can comprise applicable information related to the CCUS process. Specifically, the token can comprise the data related to performing the CCUS process that is recorded on the distributed ledger. For example, the token can comprise sensor measurements indicating how much carbon dioxide is captured and how much carbon dioxide is stored.

Rules and minting of tokens, as described, herein can be performed through smart contracts implemented through or otherwise deployed on the distributed ledger. Specifically, the smart contract can comprise the first set of rules for ensuring compliance with the first regulation. Further, the smart contract can specify to mint a token based on the rules and if the CCUS process is in compliance with the first regulation. In implementing the smart contract, a transaction can be initiated that triggers the smart contract to create a new token as applied to the CCUS process.

At module 408, the application of a second set of rules to the data is facilitated to verify the CCUS process is compliant with a second regulation. Specifically, the second set of rules can be applied in response to verification that the CCUS process is compliant with the first regulation. More specifically, the second set of rules can be dependent on regulatory compliance with the first regulation. For example, the first set of rules can verify an amount of carbon dioxide that is stored and the second set of rules can specify only applying the second set of rules if a specific amount of carbon dioxide is stored.

The second set of rules and the corresponding second regulation can comprise fiscal rules for meeting a fiscal regulation, otherwise a regulation associated with value. This is opposed to the fiscally agnostic rules that were applied at module 404. Specifically, the second set of rules can comprise one or more rules for qualifying for a fiscal carbon credit such as a tax credit. Further, the second set of rules can comprise one or more rules for qualifying for a voluntary carbon credit. Additionally, the second set of rules can comprise one or more rules for qualifying for a compliance carbon credit, e.g. a credit that allows a certain amount of emission of greenhouse gases.

Either or both the first set of rules and the second set of rules can specify that the data associated with the CCUS process needs to be verified by a third-party auditor. Specifically, either or both the first set of rules and the second set of rules can specify verification of the data associated with the CCUS process through an independent third-party, relative to the CCUS process, otherwise an entity that is not associated with or involved with the CCUS process. For example, the second set of rules can specify that Verra needs to verify the data associated with the CCUS process, e.g. according to the Verified Carbon Standard (VCS). In another example, the first set of rules can specify that the EPA needs to verify the data associated with the CCUS process.

At module 410, a second token is minted on the distributed ledger based on verification that the CCUS process is compliant with the second regulation. The second token can be minted according to an applicable technique, such as through a smart contract. The second token can comprise a fiscal token assuring regulatory compliance with the second regulation that is a fiscal regulation related to CCUS. Further, the second token can comprise a derivative token that derives value for meeting a regulation associated with a voluntary CCUS market or a compliance CCUS market. In various embodiments, the second token does not contain the data associated with the CCUS process. Further and in various embodiments, the second token comprises a reference to the first token.

Communication with an entity associated with the CCUS process can occur after compliance with either or both the first regulation and second regulation is verified. Specifically, an entity associated with the CCUS process can be communicated with to ensure continued compliance with either or both the first regulation and the second regulation. For example, an entity that stores the captured carbon dioxide can be communicated with to ensure that the sensors remain compliant with standards/regulations.

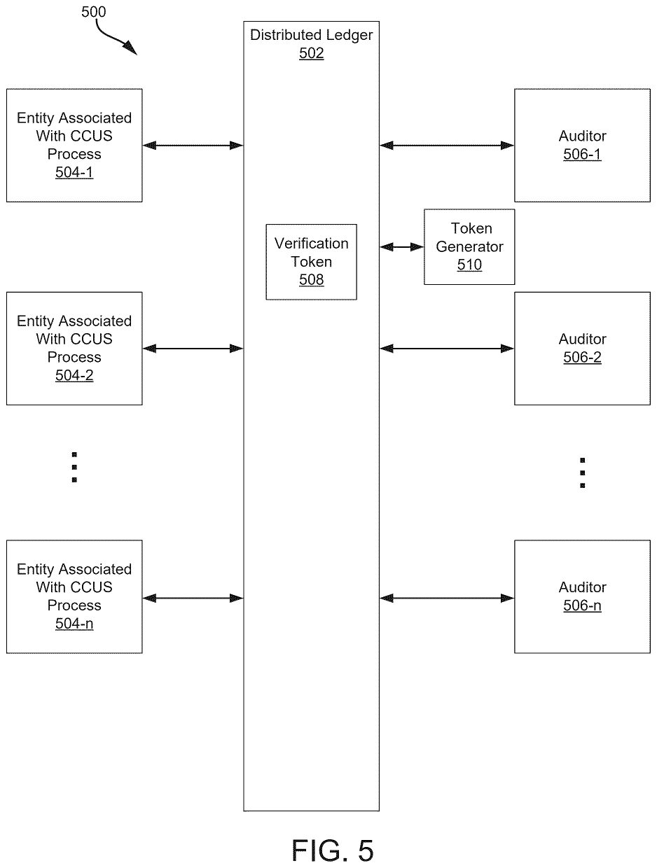

FIG. 5 illustrates a schematic representation of an environment 500 for minting tokens in association with CCUS processes, according to some examples of the present disclosure. The environment 500 comprises a distributed ledger 502, a first entity associated with a CCUS process 504-1, a second entity associated with the CCUS process 504-2 to n entity associated with the CCUS process 504-n (collectively referred to as “entities 504”). The environment 500 also comprises a first auditor 506-1, a second auditor 506-2 to n auditor 506-n (collectively referred to as “auditors 506”).

The entities associated with the CCUS process 504 and the auditors 506 can access the distributed ledger 502. Specifically, the entities 504 and the auditors 506 can record/write data to the distributed ledger 502 and read data from the distributed ledger 502. As an example, the entities 504 can write data associated with the CCUS process to the distributed ledger 502, such as sensor measurement data indicative of an amount of carbon dioxide that has been injected into a formation. The auditors 506 can access the data that is written to the distributed ledger 502 by the entities 504 and review the information. Specifically, the auditors 506 can review the information according to rules for verifying whether the CCUS process is compliant with one or more regulations. As follows, the auditors 506 can write data to the distributed ledger 502 associated with compliance verification, otherwise verification data. Verification data can comprise data indicating whether the CCUS process is compliant, the identification of the auditor that verified compliance, and the regulation(s) for which the CCUS process is compliant, and a time stamp of compliance verification.

The environment 500 comprises a verification token 508 that is minted on the distributed ledger 502 by a token generator 510. The token generator 510 functions according to an applicable system for minting tokens on a distributed ledger. Specifically, the token generator 510 can mint the verification token 508 according to a smart contract. Further, the token generator 510 can mint the verification token 508 in response to the auditors 506 verifying that the CCUS process is compliant with one or more regulations. Therefore, the verification token 508 can represent that CCUS process is compliant with the one or more regulations.

The auditors 506 be specifically selected for verifying compliance of the CCUS process. Specifically, the auditors can be selected based on characteristics of the CCUS process, a set of rules that are applied in conforming to a regulation, a standard/regulation that is applied, or a combination thereof. For example, if an EPA regulation is being tested, then an auditor associated or approved by the EPA can be selected to verify compliance with the regulation. In another example, if the CCUS process is being performed in a specific region, then a specific auditor for verifying compliance in the region can be selected.

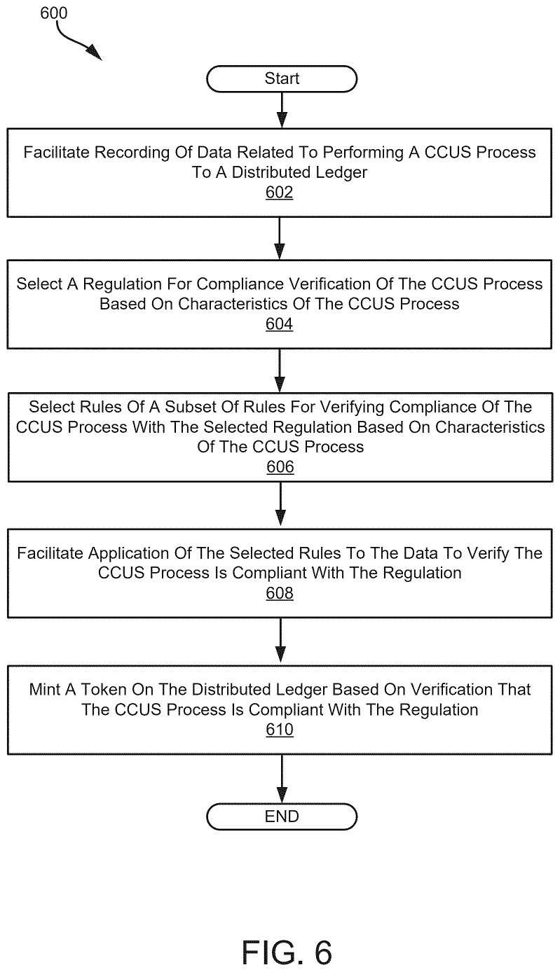

FIG. 6 illustrates a flowchart 600 of another example method of verifying regulatory compliance and providing assurance of regulatory compliance through a distributed ledger, according to some examples of the present disclosure. The method shown in FIG. 6 is provided by way of example, as there are a variety of ways to carry out the method. Additionally, while the example method is illustrated with a particular order of steps, those of ordinary skill in the art will appreciate that FIG. 6 and the modules shown therein can be executed in any order and can include fewer or more modules than illustrated. Each module shown in FIG. 6 represents one or more steps, processes, methods or routines in the method. The modules will be discussed with respect to the example environments described herein.

At module 602, the recording of data related to performing a CCUS process to a distributed ledger is facilitated. In facilitating the recording of the data, the data can be gathered from one or more SCADA systems in a CCUS environment. In turn, the data can be appended to the distributed ledger. The one or more SCADA systems can interface with the distributed ledger directly or interface with the distributed ledger through one or more edge devices independent of the one or more SCADA systems.

At module 604, a regulation for compliance verification of the CCUS process is selected based on characteristics of the CCUS process. Characteristics of the CCUS process for selecting a regulation can include applicable characteristics, such as a region in which the CCUS process occurs, what type of compliance is sought after, and a region in which compliance is sought. For example, if the goal is to verify the amount of carbon dioxide that is captured, then a specific EPA regulation can be selected.

At module 606, rules of a subset of rules for verifying compliance of the CCUS process with the regulation are selected based on the characteristics of the CCUS process. Specifically, the rules can be selected based on the regulation that is selected at module 604. Further, the rules can be selected based on a region in which compliance with the regulation is sought or a region where the CCUS process occurs.

At module 608, application of the selected rules to the data is facilitated to verify the CCUS process is compliant with the regulation. Specifically, an auditor can be selected and provided access to the data related to performing the CCUS process. In turn, the auditor can apply the selected rules to ensure compliance with the regulation.

At module 610 a token is minted on the distributed ledger based on verification that the CCUS process is compliant with the regulation. Specifically, the token can be minted in response to the auditor verifying that the CCUS process is compliant with the regulation. As follows, the token can represent that the CCUS process is compliant with the regulation.

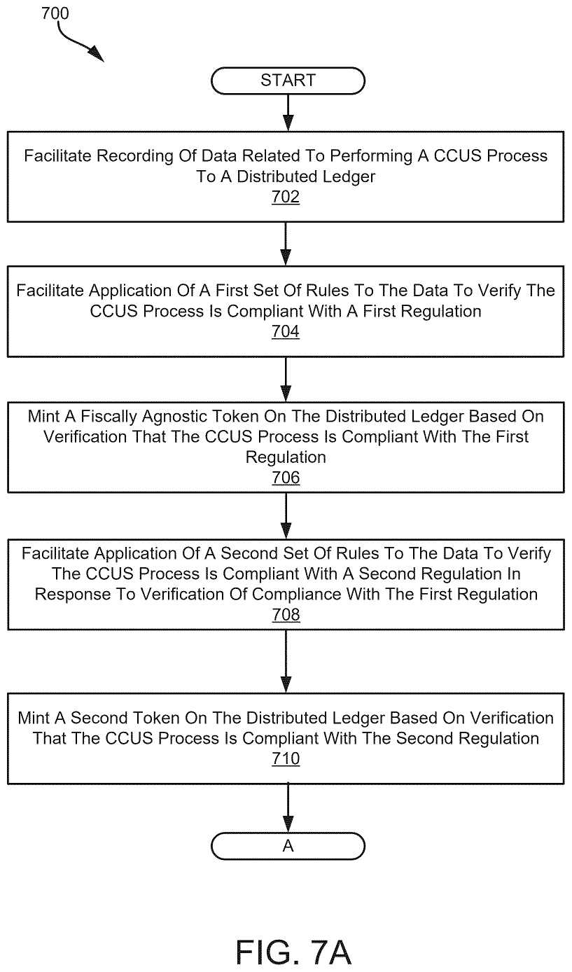

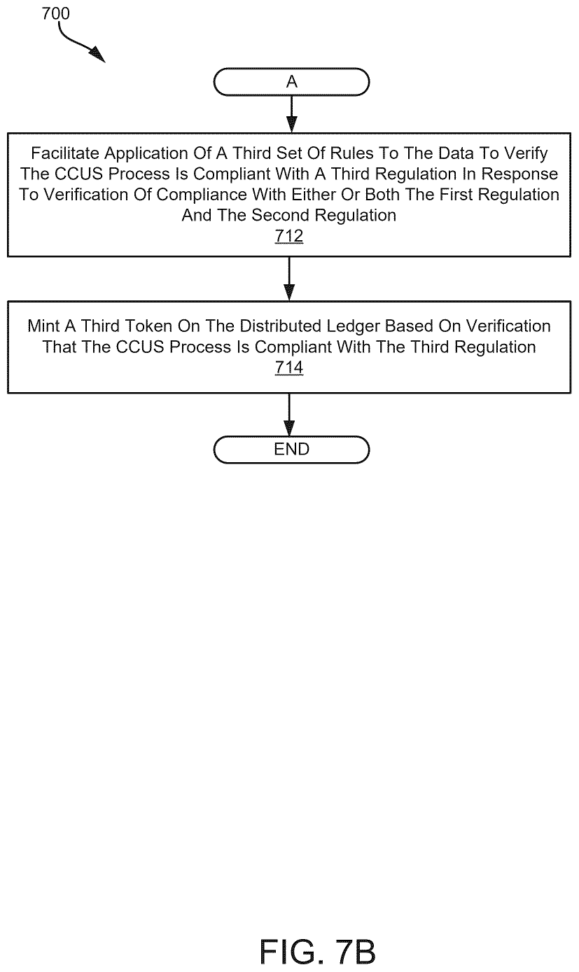

FIGS. 7A and 7B illustrate a flowchart 700 of an example method of verifying regulatory compliance and providing assurance of regulatory compliance with three different regulations through a distributed ledger, according to some examples of the present disclosure. The method shown in FIGS. 7A and 7B is provided by way of example, as there are a variety of ways to carry out the method. Additionally, while the example method is illustrated with a particular order of steps, those of ordinary skill in the art will appreciate that FIGS. 7A and 7B and the modules shown therein can be executed in any order and can include fewer or more modules than illustrated. Each module shown in FIGS. 7A and 7B represent one or more steps, processes, methods or routines in the method. The modules will be discussed with respect to the example environments described herein.

At module 702, the recording of data related to performing a CCUS process to a distributed ledger is facilitated. As discussed above with respect to module 402 of FIG. 4, an interface or other applicable system can be provided to an entity associated with performing a CCUS process through which the entity can record data related to performing the CCUS process. A CCUS process can include an applicable process that is performed during carbon capture, utilization, storage, and monitoring. As previously explained, a CCUS process can comprise the actual capture of carbon dioxide, the transportation of carbon dioxide to a storage site, and the injection of the captured carbon into the storage site. And, an entity associated with performing a CCUS process can comprise an entity who actually performs the CCUS process. Additionally, an entity associated with performing a CCUS process can comprise an entity that facilitates performance of the CCUS process. As explained above, entities associated with a CCUS process can comprise an owner of a factory that emits carbon dioxide and a third party that is responsible for capturing the emitted carbon dioxide. And, as will be discussed in greater detail later, an entity associated with performing a CCUS process, can comprise an auditor for performing an independent examination of the CCUS process, e.g. to verify regulation compliance.

Similar to module 402 of FIG. 4 discussed above, in facilitating recording of data related to performing a CCUS process to a distributed ledger, the distributed ledger can interface with a supervisory control and data acquisition (SCADA) system associated with performing the CCUS process. As discussed above, a SCADA system associated with performing a CCUS process can comprise a system that controls or facilitates performance of the CCUS process. For example, a SCADA system can control injection of captured carbon dioxide into a formation. In another example, a SCADA system can monitor the flow of carbon dioxide through a transportation network. In facilitating interfacing between the SCADA system and the distributed ledger, an interface can be provided to the SCADA through which the SCADA can automatically record data to the distributed ledger. Further, an operator can access the SCADA system for data and record the data to the distributed ledger, e.g. through the interface.

As discussed above, data related to performing a CCUS process can comprise applicable data related to performance of the CCUS process. Additionally, data related to performance of a CCUS process can comprise characteristics of compositions of tracked substances. Further, data related to performing a CCUS process can comprise data associated with recalibrating equipment and systems in a CCUS environment. Data related to performing a CCUS process can comprise data indicating when the specific equipment was recalibrated. As explained above with regard to FIG. 4, verifying the recalibration of equipment such as sensors is technically advantageous as such verification can be required for meeting compliance with certain regulations.

At module 704, the application of a first set of rules to the data is facilitated to verify the CCUS process is compliant with a first regulation. Like module 404 of FIG. 4, the first set of rules corresponding to the first regulation can comprise a regulation that is fiscally agnostic. Further, the first set of rules can comprise one or more rules related to storing and verifying an amount of carbon stored at a storage site. Additionally, the first set of rules can comprise one or more rules related to monitoring and verifying continued storage of the amount of carbon at the carbon storage site.

At module 706, a fiscally agnostic token is minted on the distributed ledger based on verification that the CCUS process is compliant with the first regulation. The token can be minted based on the first set of rules. Specifically, the token can be minted based on application of the first set of rules to ensure that the CCUS process is compliant with the first regulation. The token can comprise applicable information related to the CCUS process. Specifically, the token can comprise the data related to performing the CCUS process that is recorded on the distributed ledger. For example, the token can comprise sensor measurements indicating how much carbon dioxide is captured and how much carbon dioxide is stored.

At module 708, the application of a second set of rules to the data is facilitated to verify the CCUS process is compliant with a second regulation. Like module 408 of FIG. 4 discussed above, the second set of rules can be applied in response to verification that the CCUS process is compliant with the first regulation. More specifically, the second set of rules can be dependent on regulatory compliance with the first regulation. As discussed above, the second set of rules and the corresponding second regulation can comprise fiscal rules for meeting a fiscal regulation, otherwise a regulation associated with value. As discussed above, either or both the first set of rules and the second set of rules can specify that the data associated with the CCUS process needs to be verified by a third-party auditor. Specifically, either or both the first set of rules and the second set of rules can specify verification of the data associated with the CCUS process through an independent third-party, relative to the CCUS process, otherwise an entity that is not associated with or involved with the CCUS process.

At module 710, a second token is minted on the distributed ledger based on verification that the CCUS process is compliant with the second regulation. As explained above, the second token can be minted according to an applicable technique, such as through a smart contract. The second token can comprise a fiscal token assuring regulatory compliance with the second regulation that is a fiscal regulation related to CCUS. Further, the second token can comprise a derivative token that derives value for meeting a regulation associated with a voluntary CCUS market or a compliance CCUS market. Further, as explained above, communication with an entity associated with the CCUS process can occur after compliance with either or both the first regulation and second regulation is verified.

At module 712, the application of a third set of rules to the data is facilitated to verify the CCUS process is compliant with a third regulation. Specifically, the second set of rules can be applied in response to verification that the CCUS process is compliant with either or both the first regulation and the second regulation. More specifically, the third set of rules can be dependent on regulatory compliance with either or both the first regulation and the second regulation.

Like the second set of rules discussed above, the third set of rules and the corresponding third regulation can comprise additional fiscal rules for meeting a fiscal regulation, otherwise a regulation associated with value. This is opposed to the fiscally agnostic rules that were applied at module 704. Specifically, the third set of rules can comprise one or more rules for qualifying for a fiscal carbon credit such as a tax credit. Further, the third set of rules can comprise one or more rules for qualifying for a voluntary carbon credit. Additionally, the third set of rules can comprise one or more rules for qualifying for a compliance carbon credit, e.g. a credit that allows a certain amount of emission of greenhouse gases.

Any or all of the first set of rules, the second set of rules, and the third set of rules can specify that the data associated with the CCUS process needs to be verified by a third-party auditor. Specifically, any or all the first set of rules, the second set of rules, and the third set of rules can specify verification of the data associated with the CCUS process through an independent third-party, relative to the CCUS process, otherwise an entity that is not associated with or involved with the CCUS process. For example, the third set of rules can specify that Verra needs to verify the data associated with the CCUS process, e.g. according to the Verified Carbon Standard (VCS). In another example, the first set of rules can specify that the EPA needs to verify the data associated with the CCUS process.

At module 714, a third token is minted on the distributed ledger based on verification that the CCUS process is compliant with the second regulation. The third token can be minted according to an applicable technique, such as through a smart contract. The third token can comprise a fiscal token assuring regulatory compliance with the second regulation that is a fiscal regulation related to CCUS. Further, the third token can comprise a derivative token that derives value for meeting a regulation associated with a voluntary CCUS market or a compliance CCUS market. In various embodiments, the third token does not contain the data associated with the CCUS process. Further and in various embodiments, the third token comprises a reference to the first token.

Communication with an entity associated with the CCUS process can occur after compliance with all or any of the first regulation, second regulation, and third regulation is verified. Specifically, an entity associated with the CCUS process can be communicated with to ensure continued compliance with all or any of the first regulation, the second regulation, and the third regulation. For example, an entity that stores the captured carbon dioxide can be communicated with to ensure that the sensors remain compliant with standards/regulations.

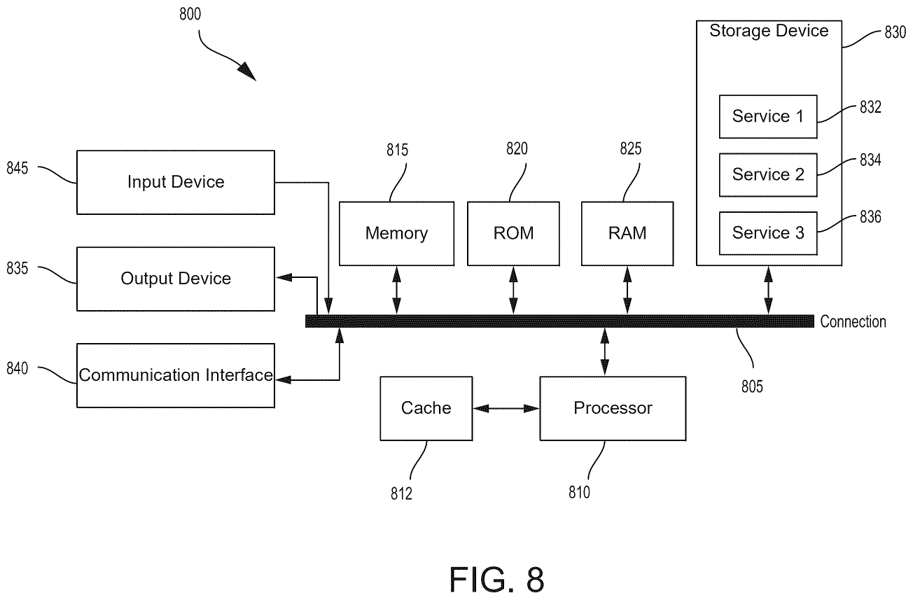

FIG. 8 illustrates an example processor-based system with which some aspects of the subject technology can be implemented. For example, processor-based system 800 can be any computing device, or any component thereof, in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

### Selected Examples

Illustrative examples of the disclosure include:

Aspect 1. A computer-implemented method comprising: facilitating recording of data related to performing a carbon capture utilization and storage (CCUS) process to a distributed ledger; facilitating application of a first set of rules to the data to verify the CCUS process is compliant with a first regulation; minting a fiscally agnostic token on the distributed ledger based on verification that the CCUS process is compliant with the first regulation, the fiscally agnostic token assuring regulatory compliance with the first regulation; facilitating application of a second set of rules to the data to verify the CCUS process is compliant with a second regulation in response to the verification that the CCUS process is compliant with the first regulation; and minting a second token on the distributed ledger based on verification that the CCUS process is compliant with the second regulation, the second token assuring regulatory compliance with the second regulation.

Aspect 2. The computer-implemented method of Aspect 1, wherein the first set of rules comprise one or more rules related to measuring and verifying an amount of carbon captured at a capture site, storing and verifying an amount of carbon stored at a storage site, monitoring and verifying continued storage of the amount of carbon at the carbon storage site, or a combination thereof.

Aspect 3. The computer-implemented method of either Aspect 1 or 2, wherein the first set of rules are configurable based on one or more characteristics of the CCUS process, the method further comprising: selecting the first set of rules as a subset of a plurality of rules; facilitating application of the first set of rules after selecting the first set of rules from the plurality of rules.

Aspect 4. The computer-implemented method of Aspect 3, wherein the one or more characteristics of the CCUS process comprise a location in which at least a portion of the CCUS process occurs.

Aspect 5. The computer-implemented method of any of Aspects 1 through 4, wherein the second token is a fiscal token assuring regulatory compliance with the second regulation that is a fiscal regulation related to CCUS.

Aspect 6. The computer-implemented method of Aspect 5, wherein the second set of rules comprise one or more rules for qualifying for a fiscal carbon credit, qualifying for a voluntary carbon credit, or qualifying for a compliance carbon credit.

Aspect 7. The computer-implemented method of either Aspect 5 or 6, wherein the second token is a derivative token that derives value for meeting a regulation associated with a voluntary CCUS market or a compliance CCUS market.

Aspect 8. The computer-implemented method of any of Aspects 1 through 7, wherein the second set of rules are dependent on regulatory compliance with the first regulation.

Aspect 9. The computer-implemented method of Aspect 8, wherein the second set of rules are configurable based on one or more characteristics of the CCUS process, the method further comprising: selecting the first set of rules as a subset of a plurality of rules; facilitating application of the first set of rules after selecting the first set of rules from the plurality of rules.

Aspect 10. The computer-implemented method of Aspect 9, wherein the one or more characteristics of the CCUS process comprise a location in which at least a portion of the CCUS process occurs.

Aspect 11. The computer-implemented method of any of Aspects 1 through 10, wherein facilitating application of the first set of rules further comprises: providing access to the distributed ledger to one or more entities associated with applying the first set of rules to verify regulatory compliance with the first regulation; and facilitating recording of verification data indicative of whether the CCUS process is compliant with the first set of rules, as determined by the one or more entities, to the distributed ledger.

Aspect 12. The computer-implemented method of Aspect 11, wherein the one or more entities associated with applying the first set of rules are selected based on one or more characteristics of the CCUS process, the first set of rules, the first regulation, or a combination thereof.

Aspect 13. The computer-implemented method of any of Aspects 1 through 12, wherein facilitating application of the second set of rules further comprises: providing access to the distributed ledger to one or more entities associated with applying the second set of rules to verify regulatory compliance with the second regulation; and facilitating recording of verification data indicative of whether the CCUS process is compliant with the second set of rules, as determined by the one or more entities, to the distributed ledger.

Aspect 14. The computer-implemented method of any of Aspects 1 through 13, further comprising: gathering the data related to performing the CCUS process from one or more supervisory control and data acquisition (SCADA) systems in a CCUS environment; and appending the data to the distributed ledger.

Aspect 15. The computer-implemented method of Aspect 14, wherein the one or more SCADA systems interface with the distributed ledger directly or interface with the distributed ledger through one or more edge devices independent of the one or more SCADA systems.

Aspect 16. The computer-implemented method of any of Aspects 1 through 15, further comprising: facilitating application of a third set of rules to the data to verify the CCUS process is compliant with a third regulation in response to the verification that the CCUS process is compliant with the second regulation; and minting a third token on the distributed ledger based on verification that the CCUS process is compliant with the third regulation, the third token assuring regulatory compliance with the third regulation.

Aspect 17. The computer-implemented method of Aspect 16, wherein the third set of rules comprise one or more rules for qualifying for a voluntary carbon credit or qualifying for a compliance carbon credit.

Aspect 18. The computer-implemented method of any of Aspects 1 through 17, further comprising interacting with an entity associated with performance of the CCUS process regarding compliance with the second regulation after the verification that the CCUS process is compliant with the first regulation.

Aspect 19. A system comprising: one or more processors; and at least one computer-readable storage medium having stored therein instructions which, when executed by the one or more processors, cause the one or more processors to: facilitate recording of data related to performing a carbon capture utilization and storage (CCUS) process to a distributed ledger; facilitate application of a first set of rules to the data to verify the CCUS process is compliant with a first regulation; mint a fiscally agnostic token on the distributed ledger based on verification that the CCUS process is compliant with the first regulation, the fiscally agnostic token assuring regulatory compliance with the first regulation; facilitate application of a second set of rules to the data to verify the CCUS process is compliant with a second regulation in response to the verification that the CCUS process is compliant with the first regulation; and mint a fiscal token on the distributed ledger based on verification that the CCUS process is compliant with the second regulation, the fiscal token assuring regulatory compliance with the second regulation.

Aspect 20. A non-transitory computer-readable storage medium storing instructions for causing one or more processors to: facilitate recording of data related to performing a carbon capture utilization and storage (CCUS) process to a distributed ledger; facilitate application of a first set of rules to the data to verify the CCUS process is compliant with a first regulation; mint a fiscally agnostic token on the distributed ledger based on verification that the CCUS process is compliant with the first regulation, the fiscally agnostic token assuring regulatory compliance with the first regulation; facilitate application of a second set of rules to the data to verify the CCUS process is compliant with a second regulation in response to the verification that the CCUS process is compliant with the first regulation; and mint a fiscal token on the distributed ledger based on verification that the CCUS process is compliant with the second regulation, the fiscal token assuring regulatory compliance with the second regulation.

Aspect 21. A system comprising means for performing a method according to any of Aspects 1 through 18.

What is claimed is:

1. A computer-implemented method implemented through one or more processors executing instructions stored on a non-transitory computer-readable storage medium, the method comprising:
facilitating recording of data related to performing a carbon capture utilization and storage (CCUS) process to a distributed ledger;
facilitating application of a first set of rules to the data to verify the CCUS process is compliant with a first regulation;
minting a fiscally agnostic token on the distributed ledger based on verification that the CCUS process is compliant with the first regulation, the fiscally agnostic token assuring regulatory compliance with the first regulation;
facilitating application of a second set of rules to the data to verify the CCUS process is compliant with a second regulation in response to the verification that the CCUS process is compliant with the first regulation; and
minting a second token on the distributed ledger based on verification that the CCUS process is compliant with the second regulation, the second token assuring regulatory compliance with the second regulation.

2. The computer-implemented method of claim 1, wherein the first set of rules comprise one or more rules related to measuring and verifying an amount of carbon captured at a capture site, storing and verifying an amount of carbon stored at a storage site, monitoring and verifying continued storage of the amount of carbon at the carbon storage site, or a combination thereof.

3. The computer-implemented method of claim 1, wherein the first set of rules are configurable based on one or more characteristics of the CCUS process, the method further comprising:
selecting the first set of rules as a subset of a plurality of rules;
facilitating application of the first set of rules after selecting the first set of rules from the plurality of rules.

4. The computer-implemented method of claim 3, wherein the one or more characteristics of the CCUS process comprise a location in which at least a portion of the CCUS process occurs.

5. The computer-implemented method of claim 1, wherein the second token is a fiscal token assuring regulatory compliance with the second regulation that is a fiscal regulation related to CCUS.

6. The computer-implemented method of claim 5, wherein the second set of rules comprise one or more rules for qualifying for a fiscal carbon credit, qualifying for a voluntary carbon credit, or qualifying for a compliance carbon credit.

7. The computer-implemented method of claim 5, wherein the second token is a derivative token that derives value for meeting a regulation associated with a voluntary CCUS market or a compliance CCUS market.

8. The computer-implemented method of claim 1, wherein the second set of rules are dependent on regulatory compliance with the first regulation.

9. The computer-implemented method of claim 1, wherein the second set of rules are configurable based on one or more characteristics of the CCUS process, the method further comprising:
selecting the first set of rules as a subset of a plurality of rules;
facilitating application of the first set of rules after selecting the first set of rules from the plurality of rules.

10. The computer-implemented method of claim 9, wherein the one or more characteristics of the CCUS process comprise a location in which at least a portion of the CCUS process occurs.

11. The computer-implemented method of claim 1, wherein facilitating application of the first set of rules further comprises:
providing access to the distributed ledger to one or more entities associated with applying the first set of rules to verify regulatory compliance with the first regulation; and
facilitating recording of verification data indicative of whether the CCUS process is compliant with the first set of rules, as determined by the one or more entities, to the distributed ledger.

12. The computer-implemented method of claim 11, wherein the one or more entities associated with applying the first set of rules are selected based on one or more characteristics of the CCUS process, the first set of rules, the first regulation, or a combination thereof.

13. The computer-implemented method of claim 1, wherein facilitating application of the second set of rules further comprises:
providing access to the distributed ledger to one or more entities associated with applying the second set of rules to verify regulatory compliance with the second regulation; and
facilitating recording of verification data indicative of whether the CCUS process is compliant with the second set of rules, as determined by the one or more entities, to the distributed ledger.

14. The computer-implemented method of claim 1, further comprising:
gathering the data related to performing the CCUS process from one or more supervisory control and data acquisition (SCADA) systems in a CCUS environment; and
appending the data to the distributed ledger.

15. The computer-implemented method of claim 14, wherein the one or more SCADA systems interface with the distributed ledger directly or interface with the distributed ledger through one or more edge devices independent of the one or more SCADA systems.

16. The computer-implemented method of claim 1, further comprising:
facilitating application of a third set of rules to the data to verify the CCUS process is compliant with a third regulation in response to the verification that the CCUS process is compliant with the second regulation; and
minting a third token on the distributed ledger based on verification that the CCUS process is compliant with the third regulation, the third token assuring regulatory compliance with the third regulation.

17. The computer-implemented method of claim 16, wherein the third set of rules comprise one or more rules for qualifying for a voluntary carbon credit or qualifying for a compliance carbon credit.

18. The computer-implemented method of claim 1, further comprising interacting with an entity associated with performance of the CCUS process regarding compliance with the second regulation after the verification that the CCUS process is compliant with the first regulation.

19. A system comprising:
one or more processors; and
at least one computer-readable storage medium having stored therein instructions which, when executed by the one or more processors, cause the one or more processors to:
facilitate recording of data related to performing a carbon capture utilization and storage (CCUS) process to a distributed ledger;
facilitate application of a first set of rules to the data to verify the CCUS process is compliant with a first regulation;
mint a fiscally agnostic token on the distributed ledger based on verification that the CCUS process is compliant with the first regulation, the fiscally agnostic token assuring regulatory compliance with the first regulation;
facilitate application of a second set of rules to the data to verify the CCUS process is compliant with a second regulation in response to the verification that the CCUS process is compliant with the first regulation; and
mint a fiscal token on the distributed ledger based on verification that the CCUS process is compliant with the second regulation, the fiscal token assuring regulatory compliance with the second regulation.

20. A non-transitory computer-readable storage medium storing instructions for causing one or more processors to:
facilitate recording of data related to performing a carbon capture utilization and storage (CCUS) process to a distributed ledger;
facilitate application of a first set of rules to the data to verify the CCUS process is compliant with a first regulation;
mint a fiscally agnostic token on the distributed ledger based on verification that the CCUS process is compliant with the first regulation, the fiscally agnostic token assuring regulatory compliance with the first regulation;
facilitate application of a second set of rules to the data to verify the CCUS process is compliant with a second regulation in response to the verification that the CCUS process is compliant with the first regulation; and
mint a fiscal token on the distributed ledger based on verification that the CCUS process is compliant with the second regulation, the fiscal token assuring regulatory compliance with the second regulation.
